(19) United States
(12) Patent Application Publication
(10) Pub. No.: US 2004/0128583 A1
(43) Pub. Date: Jul. 1, 2004

(54) Method and system for monitoring, diagnosing, and correcting system problems

(75) Inventors: Bernard Iulo, Poughkeepsie, NY (US); Theodore J. Posner, Poughkeepsie, NY (US); Pamela Posner, Hyde Park, NY (US)

Correspondence Address: Philmore H. Colburn II, Cantor Colburn LLP, 55 Griffin Road South, Bloomfield, CT, 06002, US

(73) Assignee: International Business Machines Corporation, Armonk, NY

(21) Appl. No.: 10/334,543

(22) Filed: Dec. 31, 2002

(51) Int. Cl. H04L 1/22

(52) U.S. Cl. 714/25

(57) ABSTRACT

An exemplary embodiment of the invention relates to a method and system for monitoring, diagnosing, and correcting system problems over a computer network. The system comprises a customer system, including: a server executing a plurality of software tools including a problem management tool; a client system in communication with the server via a communications link; a data storage device including a protocols definition database; and a link to a vendor system. The problem management tool includes: a user interface; a service monitor; a service application; and a service installer. The problem management tool facilitates activities conducted by the service monitor, service application, service installer. Activities conducted include monitoring the system operation of the software tools executed on the server, sending error data to the service application; and notifying a system programmer. Activities conducted further include: searching the data storage device for a vendor system related to the error data; searching and the protocol definitions database for protocols associated with the vendor system; structuring the error data according to the protocols; transmitting structured error data to the vendor system for corrective action; receiving a solution from said vendor system; and transmitting the solution to a system programmer at the customer system via the service installer.

### BACKGROUND

This invention relates generally to system maintenance of electronic data processing systems, and more particularly, the present invention relates to a method and system for monitoring, diagnosing, and correcting system problems over a communications network.

As new technology provides more affordable computers, greater numbers of these devices are finding their way into homes and businesses. Businesses in the computer manufacturing industry are competing with one another to design state of the art hardware and software that surpass existing products on the market in terms of processing speed, memory capabilities and scalability, while keeping costs in check. New and more sophisticated circuit board designs enable these manufacturers to build more compact systems without sacrificing performance. The growing popularity of the Internet has further fueled these advancements facilitating new product markets directed toward Internet-based activities, particularly in the commercial arena. E-business activities conducted over the Internet are replacing many traditional channels previously utilized by businesses. Increased demand for products that facilitate these activities, such as networking devices, hardware systems, and communications software are following suit. Integration tools for allowing older legacy systems to connect with this new electronic marketplace has also become necessary.

Maintenance for these complex and integrated systems became the next challenge for businesses. The implications of introducing highly technical and complex components into a product or system are likely to include increased risks of related malfunctions and corresponding high costs of repair. Prior to these recent technological advancements, businesses were able to save repair costs by transporting these simple computer devices to a repair office for servicing, rather than calling a technician to travel to the site. Another attempt to alleviate the high cost of providing service was for vendors to provide a document for leading untrained customer personnel through some simple problem-determination procedures (PDPs), to try to diagnose and solve some problems, or at least to isolate the problem to determine which service representative should be called. Also, diagnosis by a program running on a remote computer has been attempted. This approach, however, requires some relatively sophisticated equipment at the target system, and, if the network fails, no additional problem isolation can be done.

Current products and networking systems used in businesses today often involve multiple components or devices associated with different vendors resulting in the additional difficulty of identifying the failing device among the maze of devices operating in a network or system and then locating the appropriate vendor or servicing agent responsible for the maintenance of that device. For example, a typical computer network system in a business environment may employ multiple hardware and software products, as well as network or communications services, each of which is provided and/or serviced by a different vendor. Because it is not always possible to identify the source of the problem when a malfunction occurs, a business may need to resort to initiating a series of service calls to various vendors oftentimes resulting in futility.

The current servicing environment for most computer software systems (including operating systems, sub-systems and/or applications), involves significant manual human intervention when a problem is encountered. Although most software systems have some automated recovery built into the software, many of the problems encountered will provide for the issue of an error message, simply stop operating, or even come to an abnormal program termination (referred to as ‘abend’). Manual intervention efforts typically include: detection of the problem, collection of environmental and program- or application-specific data relating to events occurring before, during and/or after the problem was encountered; recreation of the problem in order to collect this data; reporting the problem to the servicing software vendor; working with the vendor to do problem determination and problem source identification; and waiting for the vendor to identify and provide a fix, followed by taking manual actions to install the fix. This manual intervention is costly in terms of lost production time while the problem is being resolved, and system programmer time debugging the problem and applying fixes. Most software systems today do not have a way of automatically detecting problems, collecting environmental data, reporting the same to the vendor, and receiving/installing fixes. It is therefore desirable to provide an automated solution that monitors software systems, collects data, diagnoses and has capabilities to solve a variety of software system problems, potentially even before the customer is aware that the problem exists.

### BRIEF SUMMARY

An exemplary embodiment of the invention relates to a method and system for monitoring, diagnosing, and correcting system problems over a computer network. The system comprises a customer system, including: a server executing a plurality of software tools including a problem management tool; a client system in communication with the server via a communications link; a data storage device including a protocols definition database; and a link to a vendor system. The problem management tool includes: a user interface; a service monitor; a service application; and a service installer. The problem management tool facilitates activities conducted by the service monitor, service application, service installer. Activities conducted include monitoring the system operation of the software tools executed on the server, sending error data to the service application; and notifying a system programmer. Activities conducted further include: searching the data storage device for a vendor system related to the error data; searching and the protocol definitions database for protocols associated with the vendor system; structuring the error data according to the protocols; transmitting structured error data to the vendor system for corrective action; receiving a solution from said vendor system; and transmitting the solution to a system programmer at the customer system via the service installer.

### BRIEF DESCRIPTION OF THE DRAWINGS

Referring now to the drawings wherein like elements are numbered alike in the several FIGURES:

FIG. 1 is a block diagram of a portion of a communications network within which the problem management tool is implemented in an exemplary embodiment; and

FIG. 2 is a flowchart illustrating how the problem management tool monitors, detects, and resolves system errors.

### DETAILED DESCRIPTION OF THE PREFERRED EMBODIMENT

Software systems at customer sites run at various levels of system maintenance and often encounter a problem that already has been found by another customer and often already fixed. The problem management tool of this invention provides an automated process that will intercept problems occurring during system operation and pass this information through the Internet to a related service provider in order to search for possible duplicate/already-found problems via a symptom string from the error. If a match is found a service recommendation is made, and if the fix is available, it will also be provided to the customer for installation.

The following illustrates the structural and operational aspects of the present invention.

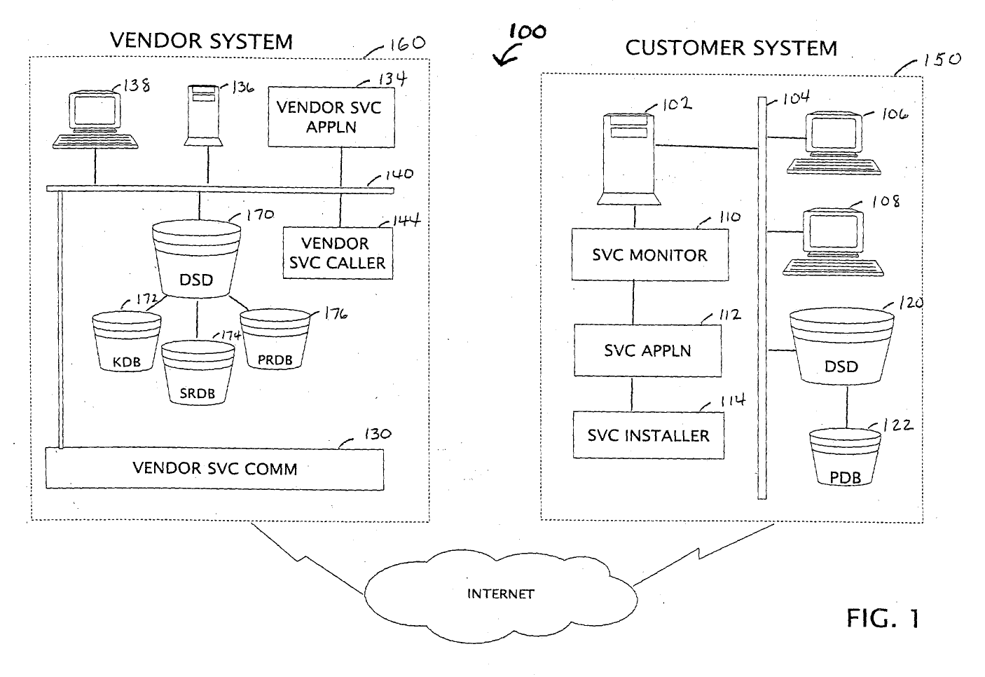

In terms of structure, reference is now made to FIG. 1. Therein depicted is a block diagram representing a network system 100 for implementing the problem management tool of the present invention. System 100 includes a customer system 150, in communication with a vendor system 160 via the Internet. The term, “customer system” is used throughout this description to refer to the system executing the problem management tool. Customer system 150 represents a business entity executing the problem management tool and either operates software provided by vendor system 160 or receives vendor-supplied system services from vendor system 160. Customer system 150 comprises a server 102 that is connected through a network 104 to client systems 106 and 108. Client systems 106 and 108 may be computer workstations or similar electronic data processing devices. Client system 106 may be operated by a programmer or administrator of customer system 150 with sufficient access permissions to exploit the resources provided by the problem management tool. Client system 108 may be operated by a representative or employee of customer system 150 with lesser or limited access capabilities. Network 104 may comprise a LAN, a WAN or other network configuration known in the art. Further, network 104 may include wireless connections, radio based communications, telephony based communications, and other network-based communications. Any server software or applications program that handles general communications protocols and transport layer activities could be used by customer system 150 as appropriate for the network protocol in use. A firewall (not shown) or other security device limits access to customer system 150 to network users, both inside and outside of customer system 150, with proper authorization.

For purposes of illustration, server 102 is an IBM® S/390 mainframe computer executing IBM® S/390 operating system software. Server 102 is also running suitable web server software designed to accommodate various forms of communications, including voice, video, and text. For purposes of illustration, server 102 is running Lotus Domino(™) and Lotus Notes(™) as its groupware, however, any compatible e-mail-integrated collaborative software could be used. Server 102 executes the problem management tool of the present invention. The problem management application may be one of many business applications employed by customer system 150 which, in combination, constitute its Enterprise Resource Planning suite. It should be noted that any suitable networking topology known in the art may be employed by customer system 150 in order to realize the advantages of the invention.

The problem management application includes a service monitor component 110, a service application component 112, and a service installer component 114. The problem management tool runs on top of the operating system of server 102 and detects error conditions, gathers environmental or problem symptoms data, determines which vendor product is failing, and sends the data to the appropriate vendor. Service monitor 110 sends the data to service application 112 via server 102 and may also alert a support programmer for customer system 150 of the problem detected. This can be done by email notification or other electronic means. Other functions of the problem management tool may be defined via its associated user interface such as setting parameters for determining which vendor products to monitor, what types of situations will require notification transmission to a customer system programmer, which programmer to notify, as well as the hours that service monitor 110 should run, and when to take automated actions as compared to holding actions until the programmer ‘releases’ the action. For example, an automated action may include installing a fix on server 102 via service installer 114 without intervention by a support programmer of customer system 150 and/or vendor system 160 personnel. Service application 112 sends this problem data over the Internet to the appropriate vendor system. Service application 112 also receives resolution data or fixes via the Internet from vendor system 160 and transmits the information to either service installer 114 or to a system programmer at client system 106 for required action and/or awareness. Service installer 114 receives information and instructions on a solution and executes the fix accordingly.

Data storage device 120 stores databases relating to documents and files created and utilized by the problem management tool. For example, data storage device 120 houses protocol definitions database 122 which is utilized by the problem management tool for reformatting various types of data and integrating data received from different sources. Protocol database 122 stores protocol definitions for each vendor resource or program for ease in communicating error incidences between customer system 150 and vendor system 160. The problem management tool identifies the appropriate vendor related to a discovered error, and retrieves the protocol associated with the vendor's product which is stored in protocol definitions database 122. The problem management tool structures the error information utilizing the protocol for transmission to the vendor system. Vendor system data may be compiled via the problem management tool whereby system resources at customer system 150 are queried periodically and/or upon new installations or reconfigurations of system devices.

Vendor system 160 comprises a server 136 that connects client system 138 to network 140 and to the Internet. Client system 138 may be a computer workstation or similar electronic data processing device. Server 136 is running suitable web server software designed to accommodate various forms of communications, including voice, video, and text, as well as groupware and email software. Network 140 may comprise a LAN, a WAN or other network configuration known in the art. Further, network 140 may include wireless connections, radio based communications, telephony based communications, and other network-based communications. Any server software or applications program that handles general communications protocols and transport layer activities could be used by vendor system 160 as appropriate for the network protocol in use. Client system 138 may access server 136 via internal web browsers (not shown) located on client systems 138. A firewall (not shown) provides security and protection against unauthorized access to internal network information from outside sources as well as controlling the scope of access to vendor system's 160 data. Hardware devices and/or software tools that provide such security are generally known in the industry and will be appreciated by those skilled in the art.

Vendor service communicator 130 operating on server 136 receives error data from customer system 150 and passes it through the firewall to vendor service application 134 for processing. Vendor service application 134 receives data from vendor service communicator 130, conducts a search for duplicate error information in knowledge database 172 and, if a match is found, transmits a resolution description and/or a fix over the Internet to customer system 150. Knowledge database 172 houses historical records of problems discovered at various customer sites which execute the vendor products and/or problems discovered via vendor system 160 personnel. Vendor service caller 144 is contacted when a match is not found in knowledge database 172. Vendor service caller 144 contacts a vendor support person or programmer and notifies this person of the error. Vendor service caller 144 then creates a new problem report with details of the error and stores the report in problem report database 176. Specialists of vendor system 160 may access this data in problem report database 176, determine resolutions as needed, and store these resolutions in service resolution database 174 for immediate and/or future executions. The vendor support person, once contacted, may then contact customer system 150 via email or phone in order to investigate the problem further and troubleshoot possible solutions. Solutions data stored in service resolution database 174 may include corrective software code, troubleshooting instructions, and upgraded tools.

Data storage device 170 is any form of mass storage device configured to read and write database type data maintained in a file store (e.g., a magnetic disk data storage device). Data storage device 170 is logically addressable as a consolidated data source across a distributed environment such as network system 140. The implementation of local and wide-area database management systems to achieve the functionality of data storage device 170 will be readily understood by those skilled in the art. Information stored in data storage device 170 is retrieved and manipulated by database management software, also implemented by server 136. For purposes of illustration, server 136 is executing IBM's DB/2® software as its database management software.

Data storage device 170 provides storage for databases used by vendor system 160 including knowledge database 172, service resolution database 174, and problem report database 176, as described above. Vendor system 160 may be an existing software supplier or software services provider for customer system 150 as well as other customer systems. Although not shown in FIG. 1, system 100 may include a plurality of suppliers or vendor systems in communication with many customer systems such as customer system 150 via the Internet, Extranet, or related networking technologies. Alternatively, the advantages of the problem management tool can be realized via a commercial service provider or application service provider (ASP) whereby many vendor products are monitored through a central location and problem resolution services provided.

The problem management tool of the present invention is an e-business application that allows customer system 150 to continuously monitor system performance, track problems or errors, identify a vendor system associated with the errors, communicate error incidences to these vendor systems, and receive assistance, all of which is accomplished in an automated fashion, with little or no human intervention, and in near real time. The tool formats system performance data acquired via service monitor 110 in order to facilitate information exchange between customer system 150 and vendor system 160.

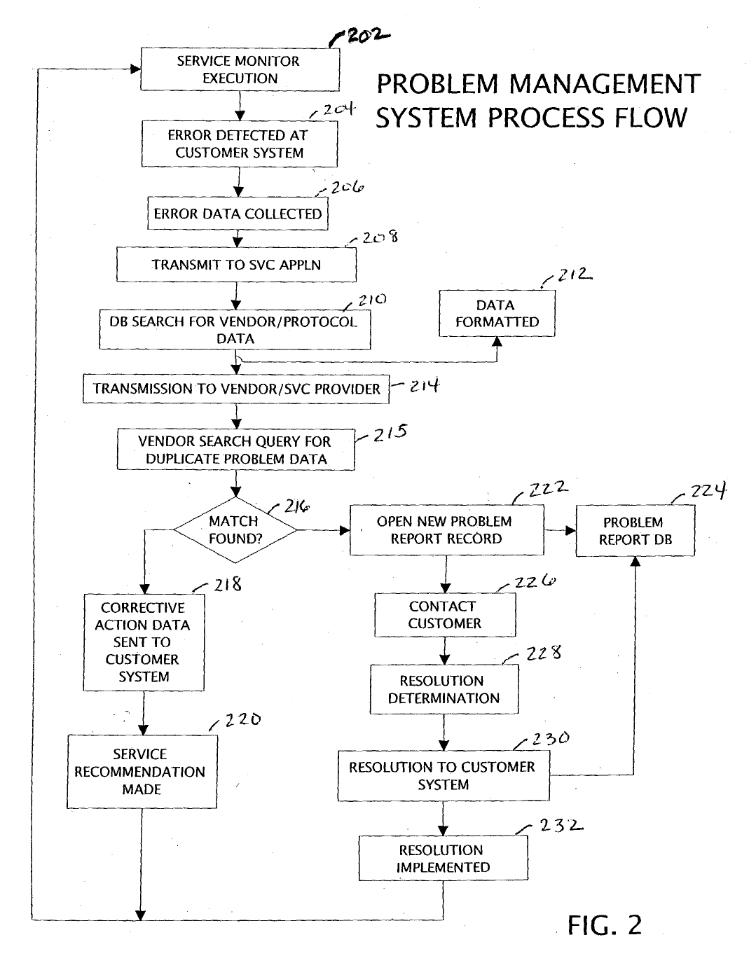

FIG. 2 illustrates the operational aspects of the problem management tool as implemented via system 100 of FIG. 1. The service monitor component 110 of the problem management tool is executed at customer system 150 at step 202. An error incident is detected by service monitor 110 at step 204. Examples of possible detectible error incidents include failing module or component, abend code, or other messages. Symptom data related to the error incident is collected by the problem management tool via service monitor 110 at step 206. Service monitor 110 sends the error data to service application 112 for further action at step 208. Service application 112 searches data storage device 120 for vendor system information in order to identify the vendor associated with the program for which the error occurred at step 210, followed by formatting this error data at step 212 via protocol definitions database 122. Formatting the data includes translating the data to coincide with vendor system's 160 resources using protocol definitions acquired from protocol database 122. As described above, protocol database 122 stores protocol definitions for each vendor resource or program for ease in communicating error incidences between customer system 150 and vendor system 160. Once formatted, the data is transmitted via service application 112 to the appropriate vendor system at step 214. Vendor system 160 performs a search of knowledge database 172 to see if this specific error type has been previously discovered and/or resolved at another customer location or at the vendor system at step 215. If a match is found at step 216, corrective action information or assistance is retrieved from service resolution database 176 and sent automatically to the affected customer system 150 at step 218. Corrective actions which may be taken include the transmission of a resolution description (i.e., instructions on how to correct the problem), an actual fix such as software code for installing on customer system 150, or reference data such as a pointer or hyperlink to a web site location where assistance can be found. If customer system 150 sets parameters utilizing the problem management tool's user interface option, the fix may be automatically installed when retrieved from service resolution database 174. Any additional service recommendations may be provided by vendor system 160 as well at step 220. The process then reverts back to step 202 where continued system monitoring is performed at customer system 150.

If no match is found, the problem management tool generates a new problem report record at step 222 and stores the information in problem report database 176 at step 224. Vendor support programmer contacts customer to investigate or troubleshoot the problem at step 226 and establishes a resolution if possible at step 228. The resolution is then transmitted back to customer system 150 at step 230 for corrective action. This information is also stored in problem report database 176 at step 224. Corrective action is taken by customer system 150 at step 232 and the problem management tool causes the system monitor execution to resume. Resolutions may then be transmitted by vendor system 160 to all customer systems known to be executing the software associated with the discovered error.

As stated above, problems previously encountered may be collected, transmitted over the Internet, and stored for immediate or future resolution resulting in an extensive library of resolutions and fixes for use by other customer systems during the time they are experiencing errors, and sometimes even before the errors are discovered. Fixes can be automatically installed at the customer location based upon the problem management tool user interface configuration. This saves time in production and programmer debugging costs.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A system for monitoring, diagnosing, and correcting system problems over a computer network, comprising:
a customer system, comprising:
a server executing a plurality of software tools;
a client system in communication with said server via a communications link;
a problem management tool executing on said server, comprising:
a user interface;
a service monitor;
a service application; and
a service installer;
a data storage device including a protocols definition database; and
a link to a vendor system;
wherein said problem management tool facilitates activities conducted by said service monitor, said service application, and said service installer.

2. The system of claim 1, wherein said activities conducted by said service monitor include:
monitoring system operation of said tools executed on said server and upon encountering an error, performing at least one of:
sending error data to said service application; and
notifying a system programmer at said customer system.

3. The system of claim 1, wherein said activities conducted by said service application include:
receiving error data from said service monitor;
searching said data storage device for a vendor system related to said error data;
searching said protocol definitions database for protocols associated with said vendor system;
retrieving said protocols;
structuring said error data according to said protocols;
transmitting structured error data to said vendor system for corrective action;
receiving a solution from said vendor system; and performing at least one of:
transmitting said solution to said service installer; and
transmitting said solution to a system programmer at said customer system.

4. The system of claim 1, wherein said service installer executes said solution.

5. The system of claim 1, wherein said protocols definition database stores formatting instructions for each vendor product utilized by said customer system.

6. The system of claim 1, wherein said user interface includes options for customizing said activities.

7. The system of claim 6, wherein said options include:
setting parameters for determining which vendor products to monitor;
defining types of situations that will require notification to a system programmer;
defining which system programmer to notify,
defining timing of operation of said service monitor; and
defining which of said activities will be automated.

8. A method for monitoring, diagnosing, and correcting system problems over a computer network via a problem management tool, comprising:
monitoring system operation of software running on a server at a customer system by a service monitor, and upon encountering an error, performing at least one of:
sending error data to a service application; and
notifying a system programmer at said customer system;
receiving said error data from said service monitor;
searching a data storage device at said customer system for a vendor system related to said error data;
searching a protocol definitions database for protocols associated with said vendor system;
retrieving said protocols;
structuring said error data according to said protocols;
transmitting structured error data to said vendor system for corrective action;
receiving a solution from said vendor system; and performing at least one of:
transmitting said solution to a service installer at said customer system; and
transmitting said solution to a system programmer at said customer system.

9. The method of claim 8, further comprising:
executing said solution by said service installer.

10. The method of claim 8, further comprising customizing activities performed by said problem management tool via a user interface, including:
setting parameters for determining which vendor products to monitor;
defining types of situations that will require notification to a system programmer;
defining which system programmer to notify,
defining timing of operation of said service monitor; and
defining which of said activities will be automated.

11. A storage medium encoded with machine-readable computer program code for monitoring, diagnosing, and correcting system problems over a computer network, the storage medium including instructions for causing said computer network to implement a method comprising:
monitoring system operation of software running on a server at a customer system by a service monitor, and upon encountering an error, performing at least one of:
sending error data to a service application; and
notifying a system programmer at said customer system;
receiving said error data from said service monitor;
searching a data storage device at said customer system for a vendor system related to said error data;
searching a protocol definitions database for protocols associated with said vendor system;
retrieving said protocols;
structuring said error data according to said protocols;
transmitting structured error data to said vendor system for corrective action;
receiving a solution from said vendor system; and performing at least one of:
transmitting said solution to a service installer at said customer system; and
transmitting said solution to a system programmer at said customer system.

12. The storage medium of claim 11, further comprising instructions for causing said computer network to implement:
executing said solution by said service installer.

13. The storage medium of claim 11, further comprising instructions for causing said computer network to implement:
customizing activities performed by said problem management tool via a user interface, including:
setting parameters for determining which vendor products to monitor;
defining types of situations that will require notification to a system programmer;
defining which system programmer to notify,
defining timing of operation of said service monitor; and
defining which of said activities will be automated.
